(19) United States
(12) Patent Application Publication
(10) Pub. No.: US 2001/0051980 A1
(43) Pub. Date: Dec. 13, 2001

(54) Preloading content objects on content exchanges

(76) Inventors: Nathan F. Raciborski, Jackson, WY (US); Mark R. Thompson, Phoenix, AZ (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/867,868

(22) Filed: May 29, 2001

Related U.S. Application Data
(63) Continuation-in-part of application No. 09/665,204, filed on Sep. 18, 2000.
(60) Provisional application No. 60/209,007, filed on Jun. 1, 2000.

(51) Int. Cl. G06F 15/16; G06F 9/00; G06F 9/46

(52) U.S. Cl. 709/203; 709/316

(57) ABSTRACT

According to the invention, a way for loading content objects in a content store on a network is disclosed. In one step, processing waits for a triggering event. It is determined if a first origin server is authorized to store content in the content store. A first content object is loaded from the first origin server onto the content store without a request for the first content object. It is determined if a second origin server is authorized to store content in the content store. A second content object is loaded from the second origin server onto the content store without a request for the second content object.

This application claims the benefit of U.S. provisional application Ser. No. 60/209,007 filed on Jun. 1, 2000 and U.S. patent application Ser. No. 09/665,204 filed on Sep. 18, 2000.

### BACKGROUND OF THE INVENTION

This invention relates in general to storing information and, more specifically, to storing information on a network.

There is an ongoing effort in the broadband industry to improve quality of service (QOS) for streaming content. Today, the Internet infrastructure is ill-equipped to provide streams of data at a constant data rate over long periods of time. One solution some have tried is to cache information at some point between the user requesting the data and the origin server providing the data.

There are many other limitations to the Internet infrastructure that affect QOS. An example of a current limitation that affects QOS are the limitations imposed by Internet service providers (ISPs) on upstream bandwidth. Typically, upstream bandwidth is limited to a fraction of the downstream bandwidth by the Internet service provider.

Limited upstream bandwidth is further constrained by peak loading conditions in oversubscribed bandwidth situations. For example, there is an increased demand on Internet systems just after work that is generally attributed to large amounts of people checking e-mail and browsing the web. This increased demand taxes all users such that each of their network connections is slow. Anything that can reduce bandwidth required during those peak periods is greatly desired.

### BRIEF DESCRIPTION OF THE DRAWINGS

The present invention is described in conjunction with the appended figures:

FIG. 1 is a block diagram of an embodiment of a content distribution system;

FIG. 2 is a block diagram of an embodiment of an active directory portion of the content distribution system;

FIG. 3A is a block diagram of an embodiment of an origin server portion of the content distribution system;

FIG. 3B is a block diagram of an embodiment of an external origin server portion of the content distribution system;

FIG. 4A is a block diagram of an embodiment of a content exchange portion of the content distribution system;

FIG. 4B is a block diagram of another embodiment of a content exchange portion of the content distribution system;

FIG. 4C is a block diagram of an embodiment of a content exchange site including multiple content exchange servers;

FIG. 5 is a block diagram of an embodiment of a client computer portion of the content distribution system;

FIG. 6 is a block diagram of an embodiment of a content distribution system;

FIG. 7 is a block diagram of another embodiment of the content distribution system that has two types of content exchanges;

FIG. 8 is a block diagram of yet another embodiment of the content distribution system;

FIG. 9 is a flow diagram of an embodiment of a process for populating the captive content exchange that has available storage capacity;

FIG. 10 is a flow diagram of another embodiment of a process for populating the captive content exchange;

FIG. 11 is a flow diagram of yet another embodiment of a process for populating the captive content exchange;

FIG. 12 is a flow diagram of an embodiment of a process for populating a distributed storage system with content from an origin server; and

FIG. 13 is a flow diagram of an embodiment of a process for providing a list of content exchanges to a client computer.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DESCRIPTION OF THE SPECIFIC EMBODIMENTS

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set for in the appended claims.

The present invention includes techniques for preloading content exchanges with content objects. Typically, the content exchanges that are preloaded are associated with client computers and origin servers. Some or all of the content objects on origin servers are loaded on the associated content exchanges. A triggering event, such as low bandwidth utilization into the content exchange, causes the content exchange to load content objects.

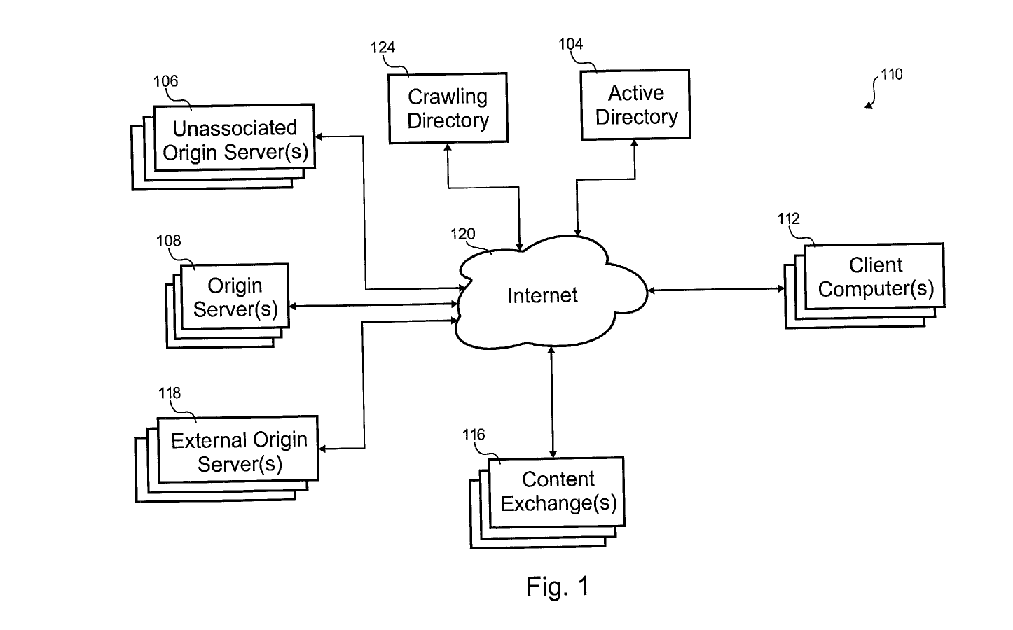

Referring to FIG. 1, a block diagram of an embodiment of a content distribution system 100 is shown. In this embodiment, the content distribution system 100 includes an active directory 104, one or more origin servers 108, one or more client computers 112, one or more content exchanges 116, one or more external origin servers 118, one or more unassociated origin servers 106, the Internet 120 and a crawling directory 124. A particular client computer 112 interacts with the active directory 104 to select a content object for download. The object can be played during download if it is streaming media or can be stored for playback at a later time. The content object could be any type of information, such as audio, video or data, that is available for download from a network. The request for the content object is forwarded to the appropriate origin server 108 along with preference information from the client computer 112. The origin server 108 decides where the object is downloaded from. In order to provide sufficient QOS, any of the content exchanges 116 or even the origin server 108 itself could provide the object.

The active directory 104 can be the interface that the client computer 112 uses for selecting a content object. Software for both the origin server 108 and optionally for the client computer 112 can be downloaded from the active directory 104 to enable the content distribution system 100. Either a directory interface page or a search interface page in the active directory 104 may be used to determine the content object desired for download. The interfaces are maintained in an active manner to avoid broken links to content objects on the origin servers 108. When a content object is requested from the origin server 108 by a content exchange 116, the active directory 104 can provide a path back to the proper origin server 108 that originated the content object.

Other embodiments could have multiple active directories. Users of the system could be divided amongst the several active directories to distribute the loading among the active directories. Additionally, the other active directories could be used for redundancy such that if one active directory were offline, the others would absorb the loading.

In some embodiments, the origin server 108 serves as the source of a content object, directs a user to a preferred source of the content object and provides directory information to the active directory 104. Content objects are introduced to the system 100 by origin servers 108. Introduction involves selection by an origin server administrator of the content objects to make available to the active directory 104. The administrator is person or system that manages the origin server 108. The content objects could include previously stored information or a streaming feed of information. According to a predetermined cycle, the origin server 108 provides a catalog of the selected information that is updated as the content on the origin server 108 changes.

The origin server 108 determines the preferred source to direct the client computer 112 to in order to download the content object. The preference list of the client computer 112, the loading of the content exchanges and the location of copies of the content object are all considerations of the origin server 108 in redirecting the client computer to the preferred source of the information. That source could be the origin server 108 itself or one of the content exchanges 116.

The user directs the client computer 112 to the location to find the desired content object and subsequently download that object. Using viewer object proxy software downloaded from the active directory 104, the client computer 112 determines the content exchanges 116 that can deliver content with the adequate QOS. The process of determining a content exchange 116 with adequate QOS involves, for example, receiving test information from the content exchanges 116 who are likely to produce the best results and preparing a preferred list based upon those test results. The user can modify the preferred list of content exchanges 116 if a customized approach is desired. When the origin server 108 is deciding the source of the requested content object, the preference information is used to provide adequate QOS.

Unassociated content servers 106 are servers on the Internet that are not formally associated with the system 100. In this embodiment, the content exchanges 116 will still cache the content objects from the unassociated content servers 106 to provide enhanced QOS to the client computers 112. In some embodiments, the users of the client computers 112 will compensate the content exchange owners for the enhanced QOS.

The external origin servers 118 can be additional sources of content objects available to the client computer 112. In an embodiment, external origin servers 118 are coupled to a content exchange(s) 116. The content objects on the external origin servers are mirrored on the distributed content exchanges to enhance distribution without overly taxing the external origin server. Client computers 112 requesting content objects from an external origin server 118 is transparently redirected to a content exchange 116 to fulfill the request for that content object.

The content exchanges 116 are storage repositories that cache content objects. A number of these content exchanges 116 are distributed to different points of the Internet 120 to cache content objects. In this way, any client computer 112 is likely to have a cache close to it on the Internet 120. Information can be cached based upon a number of considerations, such as the desirability of information to users, as a service to origin servers 108 who want their content readily available to users, as a service to users who want improved QOS, or to offload upstream bandwith. Grouping of the content exchanges 116 could be in clusters or individually to service the demand of client computers 112 for content objects.

As stated above, an origin server 108 may refer a client computer 112 request for a content object to a content exchange 116 for fulfillment of the request. When a requested content object or part of a requested content object is not found by a user requesting it from a content exchange 116, a request by the content exchange 116 to other content exchanges is made for that content object. If no other content exchanges 116 have the content object, the active directory 104 is queried for the origin server 108, unassigned origin server 106, or external origin server 188 who is the source of the content object and the content object is downloaded from there to the content exchange 116. While the content exchange 116 is gathering the content object, the client computer 112 is receiving any initial portions of the content object that are available. The content object could be stored in pieces on several content exchanges 116 and, under those circumstances, the requesting content exchange 116 will retrieve those pieces to reassemble the whole content object as needed by the client computer 112.

A crawling directory 124 is used to supplement the catalog information reported by all the origin servers 108. When searching for content objects for a user, the active directory 104 could display content objects available from the origin servers 108 as well as other content objects uncovered by the crawling directory 124 that resides on unassociated origin servers 106 or external origin servers 118. By traversing the web, crawling directories 124 catalog the content objects and other information they encounter. For example, a keyword search of the crawling directory 124 by way of the active directory 104 can direct the user to a content object on an external origin server 118 or unassociated origin server 106 that is not available from any origin server 108. One of the content exchanges 116 could be selected by the active directory 104 to cache the content object as the client computer 112 downloads it. Although only one crawling directory 124 is used in this embodiment, other embodiments could use a number of crawling directories to offer additional search results.

The Internet 120 is comprised of servers linked together by nodes. Data is divided into packets that travel through the Internet 120 by hopping from one node to the next until the destination is reached. Each packet may take a different route through the Internet and arrive at the destination at a different time. Additionally, some packets can be lost during travel through the Internet 120 as the bandwidth of any node saturates. As the number of hops between the source of a content object and the destination increases, so does the likelihood of excessive delay and packet loss.

As the content object traverses a path from source to destination through the Internet 120, the smallest bandwidth between any two nodes in the path defines the maximum bandwidth of that path. Generally, the bandwidth from the Internet 120 to the client computer (i.e., the “last mile”) has the least bandwidth allocation. At other times, however, some other hop between nodes has the smallest bandwidth. Caching the content object in a content exchange 116 with a minimal amount of hops between the content exchange 116 and the client computer 112 improves the likelihood of adequate or sufficient QOS.

Downloading the content object at a desired data-rate that does not exceed the data-rate of the client computer to the Internet 120 is adequate QOS. The maximum QOS a user can expect is defined by the speed of their network connection, the processing power of their computer and other factors. The minimum QOS is subjectively defined by the user based upon the quality they desire within certain limits. For example, a user with a 400 Kbps network connection and a fast computer may have a choice of a 28 Kbps, 56 Kbps, or 128 Kbps stream for an audio clip from which the user chooses the 128 Kbps stream. So long as the datarate provided by the client computer is in the range of 128-400 Kbps, adequate QOS is possible for that stream.

Although the above embodiment primarily uses the Internet 120 as a connection between the various blocks, other embodiments could use private links outside or in parallel to the Internet 120. The private links could allocate bandwidth sufficient for improved QOS or use other techniques to improve QOS. Additionally, content objects on external origin servers 118 or unassociated origin servers 106 could benefit from the system 100 to the extent caching, encryption and compression is provided.

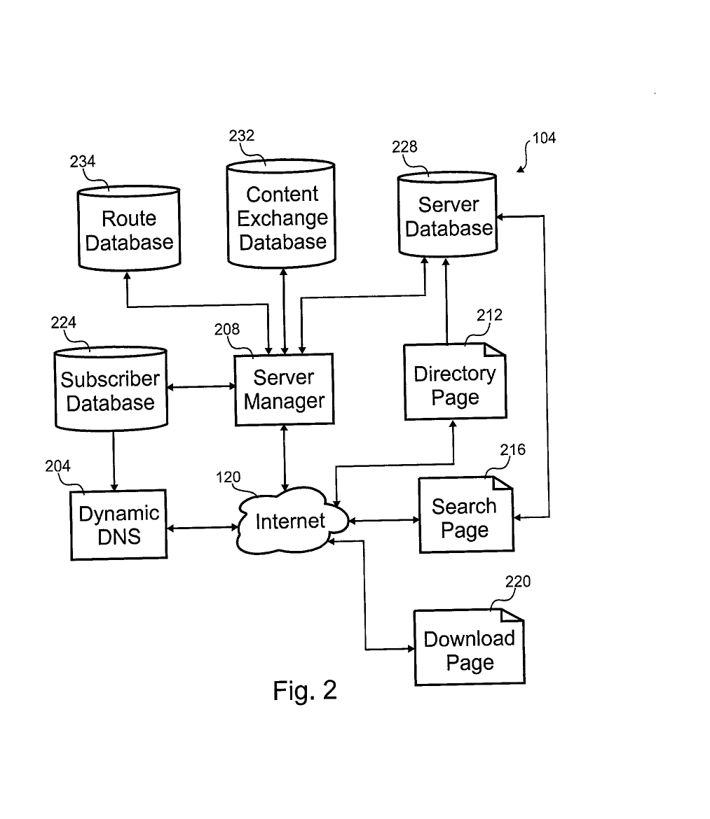

With reference to FIG. 2, a block diagram of an embodiment of an active directory portion 104 of the content distribution system 100 is shown. Included in the active directory 104 are a dynamic domain name server (DNS) 204, a server manager 208, a directory page 212, a search page 216, a download page 220, a subscriber database 224, a server database 228, a content exchange database 232, and a route database 234. The content distribution system 100 interacts with the active directory 104 to provide directory information to the user and assist in downloading a content object to the user.

Both the user of the client computer 112 and the administrator of the origin server 108 are subscribers to the content distribution system 100. Software is downloaded from a download page 220 to the user and/or administrator. The software for the client computer 112 is optional in some embodiments and improves QOS when installed. The software for the origin server 108 allows the active directory 104 to update the content available on the system 100 and to direct the client computer 112 to a preferred source for receiving that content.

The client computer 112 attaches to the domain of the active directory 104 to find a desired content object. Depending on preference, the user may use a directory page 212 or search page 216 to find the content object. The search page 216 may be a traditional boolean search engine that accesses a catalog of the content objects provided by all origin servers 108 as well as information gathered from the crawling directory 124. Other embodiments could only display information from the crawling directory 124 after a search of the content from the origin servers 108 is unsuccessful or omit information from the crawling directory 124 altogether. The catalog of content objects for all origin servers 108 is maintained in the server database 228.

The directory page 212, in this embodiment, organizes the possible content objects in a hierarchy of categories that are organized by subject. For example, the first page might show a number of topics of general interest where the user selects sports. In the next page, which is one level down in the hierarchy, a number of sports are displayed where the user selects football. Down another level in the hierarchy, the user may select the San Diego Chargers™ to see another page of related content object links. Each link points to the origin server 108 that originated the content object.

The administrator categorizes the content on the origin server 108 to allow the directory page 212 to present it properly. On a site, directory or file basis, the administrator can choose a category for content objects in an HTML SSI tag associated with that content object. This classification is harvested and stored on the active directory to allow presenting content objects in different categories. Additionally, a moderator may describe and arrange content objects in the categories for the directory page 212. For example, the moderator could mark certain content objects for more prominent display and/or add a review and/or synopsis for the content objects.

The server manager 208 maintains information on all client computers 112, all origin servers 108, all external origin servers 118, all content exchanges 116, and all content objects on origin servers 108. The information related to client computers 112 and origin servers 108 is maintained in the subscriber database 224. The full name, a login name, a password, a unique identifier, token credits available, and other information is maintained in the subscriber database 224 for each user associated with a client computer 112. This database 224 also holds the last time the origin server 108 was verified, an Internet Protocol (IP) address for the origin server 108, the port the content manager server runs upon, on-/off-line status of the origin server 108, a banner ad URL, a name for the origin server 108, a description of the origin server 108, the credits or tokens needed to use the origin server 108 or other billing model, and the number of connections or viewers allowed at one time.

Information on content objects for all origin servers 108 is maintained in the server database 228. For each content object, the origin server name, content object file name and path are stored along with category information, a brief description and keywords. The server database 228 is queried to provide content selections to the user during navigation of the directory and search pages 212, 216. To maintain current information in the server database 228, the server manager 208 periodically interacts with the origin server 108 to get the most recent changes to the catalog of content objects and to determine if the origin server 108 has gone offline. Whenever an origin server 108 goes offline, the entries in the server database 228 corresponding to that origin server 108 are removed and the status information in the subscriber database 224 is updated.

In some embodiments, the entries in the server database 228 remain even after the origin server 108 goes offline. The status is updated to reflect that the content associated with the origin server is unavailable, but the information remains stored in the server database 228. If the status is updated to online, the information is once again presented to users that are searching for content objects. In some circumstances, an origin server 108 may indicate to the active directory 104 that it is going offline for a period of time. Presuming the period of time is short, the active directory can keep information in the server database 228 without presenting it to users.

A list of the content exchanges 116 available to the system 100 is maintained by the server manager 208 in the content exchange database 232. In some embodiments, the content exchange database 232 can include a list of IP addresses for all possible content exchanges 116 within the content distribution system 100. Further, the content exchange database 232 can include a number of content exchange fields associated with each content exchange 116. For example, fields associated with each content exchange 116 in the content exchange database 232 can include a content exchange identifier, a content exchange site, a content exchange provider, a content exchange name, a content exchange location, a content exchange status, an icon, or any other desired information.

Together, the content exchange identifier and content exchange site identify a unique content exchange 116 at a particular content exchange site. The content exchange provider is an indicator of the party responsible for the content exchange, such as XYZ company. The content name is a domain name and the content exchange location can be geographic coordinates for a content exchange 116. In an exemplary embodiment, the content exchange database 232 includes a content exchange identifier, a content exchange site, a content exchange IP address, a content exchange provider, a content exchange name, a content exchange location, and an icon for each content exchange 116 in the content exchange database 232.

In general, the content exchange database 232 can be regionalized or partitioned by a variety of methods including, but not limited to, improved QOS criteria or subscription services criteria. Additionally, the content exchange database 232 can include a listing of alternative active directories 104, origin servers 108, or any other useful information.

The content exchanges 116 in the system 100 regularly provide status to the server manager 208. As content exchanges 116 become available or unavailable, their operational status is reported to the server manager 208 and recorded in the content exchange database 232. In some embodiments, the content exchange database 232 can include additional status information including content exchange 116 loading, capacity, utilization, health, etc.

The routing database 234 includes a list of external origin servers 118. In some embodiments, the routing database 234 includes identification, status and organization information related to the external origin servers 118. Identification information can include an IP address and a domain name for an external origin server 118. Status information can include availability, loading or other status about the external origin server. Organization information can include a list of alternative external origin servers 118. In an embodiment, the routing database 234 includes an IP address and a domain name for each external origin server 118. In some embodiments, identifying an external origin server 118 in the routing database 234 is the mechanism for associating the external origin server 118 with the content distribution system 100.

For each external origin server 118 in the routing database, there are a list of user names that are allowed to use a content exchange 116 to access the information on the external origin server 118. The user name is unique to the user of the client computer 112. A list of external origin servers 118 a client computer can route through a content exchange 116 is provided to the client computer 112. The client computer 112 uses the information from the routing database to redirect user requests for an external origin server 118 to a content exchange 116. After the content exchange 116 populates with the content objects from the external origin server 118, bandwidth is offloaded from the external origin server 118 to the content exchange 116. The user may compensate the owner of the content exchange 116 and/or the administrator of the origin server 108 for this enhanced service.

The dynamic DNS 204 provides an origin server name for each IP address for the origin servers 108. The origin server name uniquely identifies the origin server 108 on the Internet 120. This information is maintained in the subscriber database 224. The content exchange 116 does not know the IP address of the origin server 108 that provided the content object to the content exchange 116, but knows the origin server name. When a content exchange 116 wants to populate its cache with a content object or a portion of a content object that is not available from other content exchanges 116, the dynamic DNS 204 is queried to determine the IP address or domain name of the origin server 108 that is the source of the content object. If a domain name is retrieved from the dynamic DNS 204, the IP address corresponding to that domain name is retrieved from a DNS.

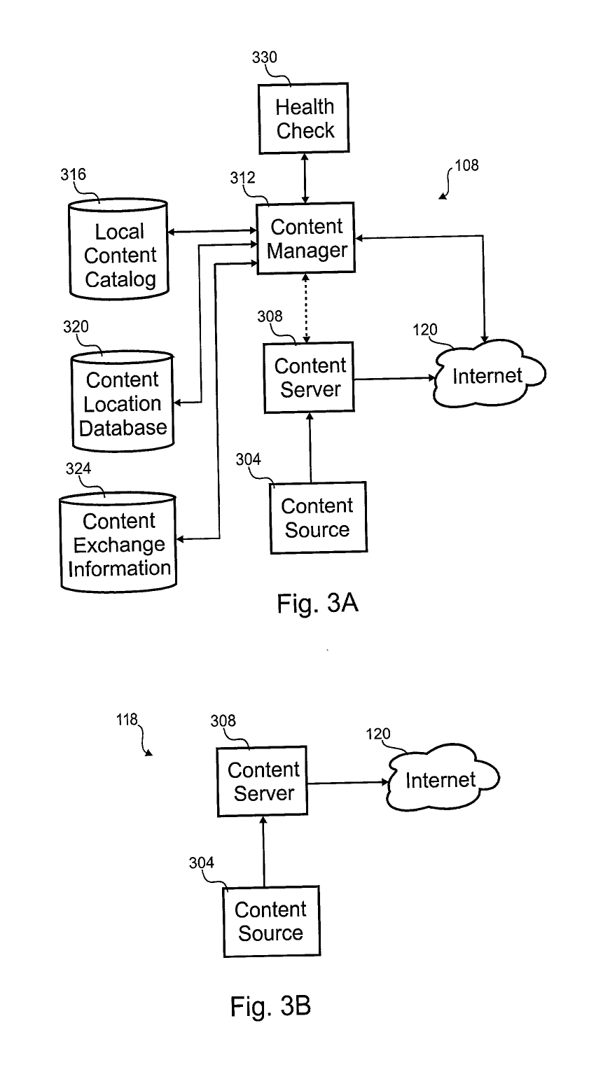

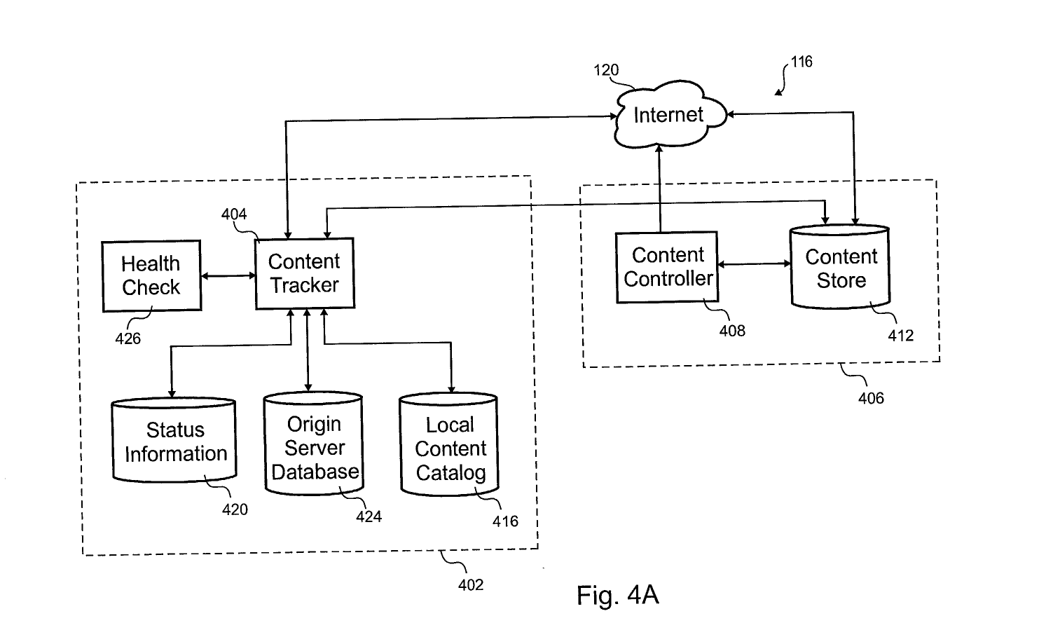

Referring next to FIG. 3A, a block diagram of an embodiment of an origin server portion 108 of the content distribution system 100 is shown. The origin server 108 is managed by an administrator and provides one source of content objects to the content distribution system 100. QOS is provided by the origin server 108 directing the client computer to a content exchange 116 that can adequately deliver the desired content object. Included in the origin server 108 are a content source 304, a content server 308, a content manager 312, a local content catalog 316, a content location database 320, content exchange information 324, and a health check 330.

Content is provided to the origin server 108 by a content source 304. The content source 304 could include a live web cam, a video or audio feed, a data object, a data stream, a video tape or audio tape, an optical or magnetic disk, or any other content delivery mechanism. Content objects are delivered by the content source 304 to the content server 308 for possible distribution to the system 100.

Time and date information is maintained in each content exchange 116 for the content objects or portions of content objects maintained therein. The time and date information allows distinguishing content objects which may have the same origin sever name, path name and file name. Other embodiments could alternatively use any unique code such as a checksum, CRC or hash to uniquely identify a content object.

All content objects of the origin server 308 are stored on the content server 308. The administrator can select a content object or groups of content objects for publishing to the system 100 while leaving other content objects on the content server 308 such that they are unavailable to the system 100. Some content objects are discreet files, but others are streams of content produced, for example, by live web cams. In some embodiments, the software that runs the content server 308 may be integrated with the software of the content manager 312.

The content manager 312 publishes the desired content objects to the system 100 and directs users to the preferred content exchange 116 for downloading content objects associated with the content manager 312. At the direction of the administrator, the content manager 312 selects content objects or groups of content objects by filename, directory or drive volume for publishing to the active directory 104. Some content objects on the content server 308 may be excluded from publishing such that they are not available to the system 100.

The content objects selected for publishing to the system are maintained in a local content catalog 316. Entries in the local content catalog 316 are kept current by the content manager 312 as the objects corresponding to those entries may become unavailable or updated. For each entry, the content object file name and path are stored along with category information, a brief description and keywords. Upon attachment to the system 100, the local content catalog 316 is sent by the content manager 312 to the active directory 104 for entry to the server database 228. Periodically, changes to the local content catalog 316 are sent to the server database 228 to keep the directory information as current as possible. Updates could happen on a regular interval such as every two minutes and/or whenever a change in the local content catalog is made.

The content manager 312 also knows the location of all portions of content objects associated with that content manager 312. Upon attaching to the system 100, the content manager 312 contacts each of the content exchanges 116 for status. Each of the content exchanges 116 periodically reports on its content object or content object portions to the originating content managers 312. Armed with this information, the content manager 312 can direct a client computer 112 to a content exchange 116 that may have some or all of the desired content object available for download.

Location information for content objects that is reported by all the content exchanges 108 is maintained by the content manager in the content location database 320. By querying the content location database 320, the content manager 312 can determine the content exchanges 116 that contain a content object or a portion of a content object. During the routing of the client computer 112 to a content source, the presence of the content object in a particular content exchange 112 can affect the routing determination.

The content exchange information store 324 holds information on all active content exchanges 116. Upon power-up of the origin server 108, the content exchange database 232 in the active directory 104 is downloaded into the content exchange information store 324. All the content exchanges 116 listed in the content exchange information store 324 are queried after power-up for status information that is retained as content exchange information 324. The status information includes the number of concurrent links used, total number of concurrent links allowed, bandwidth utilization, and cache chum rate. The chum rate of the cache is the amount of time unused data remains in the cache and is indicative of the loading of the cache. For example, data is usually flushed out of the cache quickly for content exchanges 116 that are busy relative to the amount of storage in the cache. However, some embodiments that could have sticky content objects that remains pinned in the content exchange 116 for a period of time regardless of use.

The content manager 312 intelligently redirects the client computer 112 wanting a content object to the preferred source for that object. Preference information provided from the client computer 112 is used to determine the sources of the content object preferred by the client computer 112. This information is used along with the current locations of the content object and the loading of the possible content exchanges in order to direct the client computer 112 to the preferred content exchange 116 for download of the content object.

In some embodiments, the content manager 312 can regulate access to content objects. When a client computer 112 attempts to download a content object associated with a content manager 312, a login dialog can be presented if the administrator has secured the content object. The user may enter a user name and/or password in the login dialog to enable redirection of the client computer 112 to a source for the content object. This user name and/or password is in addition to any required for the active directory 104. Before redirecting the client computer 112 to that source, the user name and/or password or login information is checked against a list of acceptable login information previously stored on the origin server 108. Access to a whole origin server 108 or a volume, a directory or a content object on the origin server 108 may be regulated in this manner.

Some embodiments allow the origin server 108 or active directory 104 to preload content objects on a content exchange 116. The requests for content objects are monitored to determine desirability. Desirability information, billing information, size, and/or other considerations are used to determine which content objects to preload on a content exchange 116. Either the origin server 108, active directory 104 or content exchange 116 can request the content objects from a content exchange 116 to preload them there. Periodically, the content objects could be requested for a content exchange 116 to keep them loaded on the content exchange 116 such that they are not unloaded because of inactivity. Other embodiments could designate the content objects as sticky content objects as described above.

The health check 330 can be either a hardware or software application which provides operational characteristics of an associated origin server 108. In an embodiment, the health check 330 provides a single indication of origin server 108 status. The single indication is a normalized value between zero and one indicating a combination of origin server characteristics. For example, it could include a CPU load, a CPU temperature, a number of concurrent connections, and/or a number of requests an origin server is facilitating. In an alternate embodiment, the health check 330 could monitor characteristics of a content exchange 116 while running on another content exchange 116 or origin server 108.

Referring next to FIG. 3B, a block diagram of an embodiment of an external origin server portion 118 of the content distribution system 100 is shown. The external origin server 118 differs from the origin server 108 in that the external origin server 118 does not have content manager software installed upon it. Included in the external origin server 118 are a content server 308 and a content source 304.

The administrator of the external origin server 118 determines one or more client computers 112 authorized for receiving content objects through a content exchange 116. The routing database 234 is updated by the administrator to allow individual client computers 112 to access the content objects through a content exchange 116. A web page on the active directory provides an interface to entering information on client computers 112 into the routing database 234. Other embodiments could automate the interface between the external origin server 118 and the routing database 234 such that users are automatically added to the routing database 234 upon signing up with the external origin server 118.

The updates to the routing database 234 are downloaded and stored locally by client computer 112. Subsequent attempts to access the external origin server 118 are redirected to a content exchange 116 to service that request. Redirection in this way allows an external origin server 118 to redirect client computers 112 to a content exchange 116 without assistance from content manager software.

An external origin server 118 may have one or more content exchanges 116 assigned to carry content objects for the external origin server 118. The routing database 234 could redirect subscribing client computers to one or more of these content exchanges 116. If the client computer were allowed to use two or more of these content exchanges 116, a client-side routing analysis would be performed on the two or more content exchanges to allow ranking of the relative QOS between them.

The content objects of an external origin server 118 can be preloaded to a content exchange(s) allocated to provide those content objects. To decrease latency when a content object is requested for the first time, the active directory 104 can crawl the external origin server 118 to determine the content objects available from that server 118. The available content objects may be added to the crawling directory 124. Once the available content objects are known, the active directory 104 requests each content object from the associated content exchange(s) in order to cause loading of each content object on the associated content exchange(s). In this way, content objects are preloaded on the associated content exchanges.

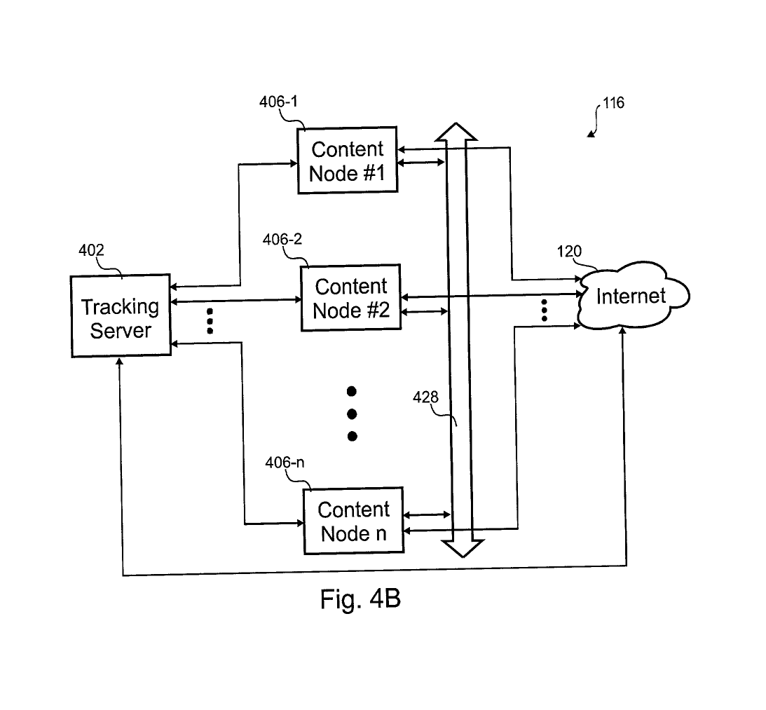

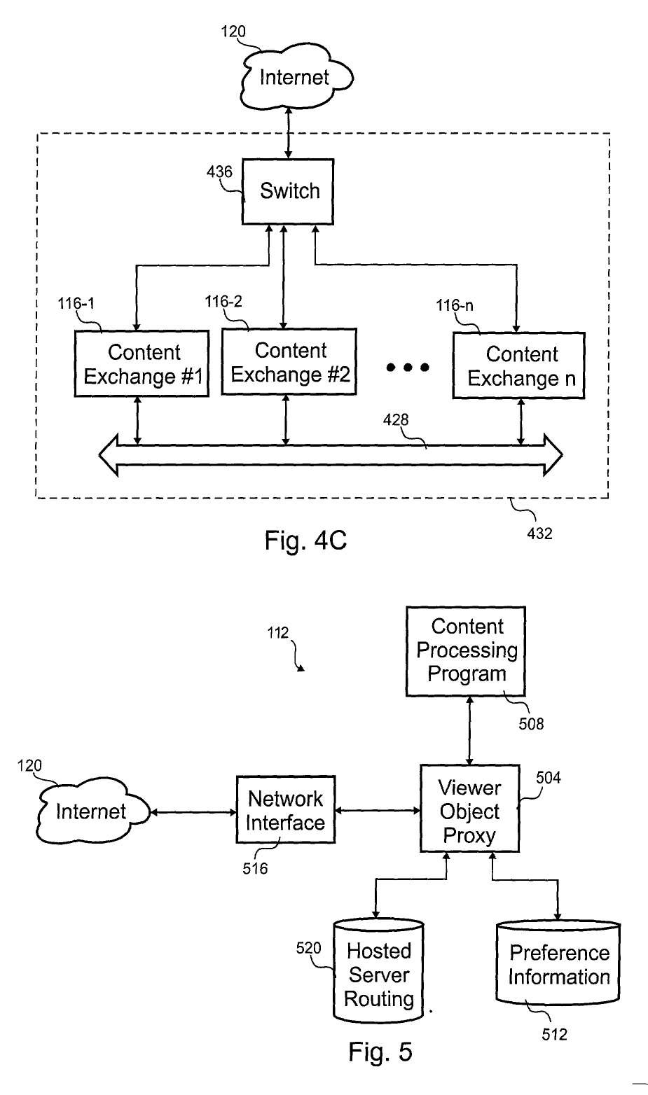

With reference to FIG. 4A, a block diagram of an embodiment of a content exchange portion 116 of the content distribution system 100 is shown. The content exchange 116 caches content objects requested by client computers 112 under the control of the content manager 312. Included in the content exchange 116 are a tracking system 402, and a content node 406. The tracking system includes a content tracker 404, a health check 426, status information 420, a local content catalog 416, and an origin server database 424 while the content node 406 includes a content controller 408 and a content store 412.

The health check 426 can be either a hardware or software application which provides operational characteristics of an associated content exchange 116. In an embodiment, the health check 426 provides a single indication of content exchange 116 status. The single indication may be a normalized value between zero and one indicating a combination of content exchange characteristics including, for example, a CPU load, a CPU temperature, a number of concurrent connections, and a number of requests a content exchange is facilitating. In an alternate embodiment, the health check 426 could monitor characteristics of a content exchange 116 while running on another content exchange 116, origin server 108 or other location.

The content store 412 holds the content objects available for download to the client computers 112 from that content exchange 116. The name of the origin server 108 providing the content object along with path information and the filename is stored with the content object in the content store 412. Via the Internet 120, the client computers 112 connect to the content store 412 and download the content object file or data stream. As new content objects are added to the content store 412, old content objects are typically removed. The age of a content object relates to the last time a content object was accessed. Some content objects on the store 412 never age such that they stay in the store 412 for a predetermined time. An origin server 108 could arrange for the content exchange 112 to store a content object for a predetermined period of time.

When the client computer 112 requests a content object from the content store 412, the content object may not be currently loaded in the content store 412. The content store 412 notifies the content controller 408 of the unfulfilled request for the content object. The content controller 408 locates missing content objects or portions thereof in other content exchanges 116 or from the content server 308 that originated the content object. The missing content objects are loaded into the content store 412 by the content controller 408 such that the client computer 112 can download this information.

When a content object is missing from content store 412, the content controller 408 first checks with other content exchanges 116 to determine if the object is available. If no content exchange 116 has the desired content object, the content server 308 that originated the information is queried for the content object. The content store 412 does not include the IP address for the originating content server 308 so the dynamic DNS 204 is queried for that information. Given the origin server name, the dynamic DNS 204 provides the IP address such that the content controller 408 can request the content object from the proper content server 308.

The content tracker 404 reports to the system 100 the current items in the content store 412 and status information for the content exchange 116. The local content catalog 416 records the origin server name, path and filename for each content object or portion of a content object in the content store 412. As new items are added to and old items are removed from the content store 412, the local content catalog 416 is updated. When a content manager 312 connects to the system 100, a query is made to all content trackers 404 to determine what portions of content objects are stored on the content stores 412. The initial query provides a baseline to which the content tracker 404 updates as changes are made to the various content stores 412. The changes are sent directly to each of the content managers 312 that has content stored in the content store 412. The dynamic DNS 204 is used during this process to determine the IP address corresponding to the origin server name for each content object.

The content tracker 404 also provides status information 420 for the content exchange 116 to the content mangers 312. The status information 420 is sent periodically to each of the content managers 312 as a broadcast or multicast, for example, every five minutes and/or when changes occur. The status information 420 could include the number of concurrent links to the content exchange currently in use, the total number of concurrent links allowed, the bandwidth utilization, the cache churn rate, and/or other information. In other embodiments, the status information is posted to a central location that the content manager 312 can query when determining where to send a client computer 112 for a downloading a content object.

The content tracker 404 maintains the origin server database 424 to track the origin servers 108 active in the system 100. After attaching to the system, all origin servers 108 identify themselves to the content trackers 404. The content trackers 404 record the origin server name and IP address in the origin server database 424. A query to the dynamic DNS provides the IP address for a given origin server name. If an origin server 108 notifies the content tracker 404 of impending unavailability or if the content tracker 404 cannot contact a particular origin server, the entry for that origin server is removed from the origin server database 424. Additionally, the content corresponding to that origin server 108 may be purged from the content store 412, and the local content catalog 416 is updated. In some embodiments, the content object and content object portions are not purged, but are simply tagged for deletion as the storage space is requested.

In some embodiments, the content controller 408 can be instructed by the system 100 to acquire and retain predetermined content objects in the content store 412. Content objects that are anticipated to be wanted can be preloaded in preparation for the demand. The desirability of a content object can be determined by monitoring click-throughs to those content objects from the search and directory pages 212, 216. For example, content objects related to a famous person could be loaded onto content stores 412 immediately before a biography program on the famous person is aired on network television. Alternatively, users could subscribe to a service that loads content objects to some content exchanges 116. For example, a scheduled network program could be loaded to coincide with a TV broadcast the user could view over the Internet 120 in lieu of the TV broadcast. In this way, the content would be available without delay to the subscribed users.

With reference to FIG. 4B, a block diagram of another embodiment of a content exchange portion 116 of the content distribution system 100 is shown. This embodiment includes multiple content nodes 406 coupled to a single tracking server 402. A content bus 428 allows content nodes 406 to check each others content stores 412 for missing content objects. The content bus 428 could also couple to other content notes in other locations. The content bus 428 may or may not travel in part over the Internet 120.

Referring next to FIG. 4C, a block diagram of an embodiment of a content exchange site 432 including multiple content exchange servers 116 is shown. Even though the content exchange site 432 includes multiple content exchange servers 116, it appears to the system a single content exchange 116. The load of the content exchange site 432 is distributed among the constituent content exchange servers 116. A switch 436, such as a layer four switch, distributes the content object requests to the content exchanges 116 and aggregates the spooled responses to the Internet 120.

Referring next to FIG. 5, a block diagram of an embodiment of a client computer portion 112 of the content distribution system 100 is shown. The client computer 112 communicates to the Internet 120 in order to deliver content to a user. Included in the client computer 112 are a viewer object proxy 504, a content processing program 508, preference information 512, a network interface 516, and hosted server routing 520.

The content processing program 508 is typically software that interprets or processes a content object downloaded from the Internet 120. Examples of content processing programs 508 include web browsers, file transfer protocol (FTP) software, gopher software, news (NNTP), mail programs, streaming media players, non-streaming media players, and other software. The Internet communication from content processing program 508 that is normally sent directly to the Internet is redirected to the viewer object proxy 504.

The viewer object proxy 504 serves as intermediary between the Internet 120 and the content processing program 508. After installation of the viewer object proxy 504, it determines its general location relative to known points on the Internet 120. Content exchanges 116 that are reasonable candidates for providing sufficient QOS are tested to determine the number of hops necessary to reach each content exchange 116 and the latencies between each content exchange 116 and the viewer object proxy 504. A weighting of QOS factors, such as the number of hops and bandwidth achieved, is recorded as preference information 512 and is passed as meta-data to the content manager 312 in an HTTP header.

Other embodiments could pass meta-data in any sort of data channel and not just through a HTTP header. For example, the meta-data could travel through a dedicated port, an IP address, a URL, a header, or other logical channel.

The preference information 512 is the result of network analysis performed from the client computer perspective 112. When a content object is requested, the preference information 512 is communicated to the content object manager 312 which in turn selects an appropriate content exchange 116 for the client computer 112. Periodically, such as every hour, the preference information 512 is updated using automated tests or is updated manually by the user. Subsequent tests take into account the previous results to efficiently consider preferred content exchanges. For example, the first analysis may check one hundred content exchanges, but a subsequent analysis could eliminate the poor performing content exchanges such that only fifty are analyzed.

The preference information 512 includes a list of content exchanges 116 and their associated QOS values resulting from client-side network analysis. In some embodiments, there are multiple pathways to an external origin server 118. The multiple pathways are separated by port, IP address, server identification (ID), and/or other mechanisms. Client-side network analysis could be used to determine a QOS value associated with each pathway to an external origin server 118 or any other source of a content object that could also have multiple pathways.

After the user of the client computer 112 chooses a content object, the origin server name is provided to the viewer object proxy 504. The origin server name is used for the viewer object proxy 504 to query the dynamic DNS 204 for the IP address of the origin server 108. Once the IP address is known, the content processing program 508 is redirected to the content manager 312 for the desired content object. The content manager 312 is passed the preference information 512 to allow routing the client computer 112 to the appropriate content exchange 116. In this embodiment, the preference information 512 includes the preferred ten content exchanges, but the amount of preferred content exchanges could be adjusted by the user.

In some embodiments, the viewer object proxy 504 can be HTTP-specific but protocol independent for routing information. Thus, routing information is transferred according to HTTP, but the actual routing information is protocol independent. However, one skilled in the art would recognize that the viewer object proxy 504 can also be configured to work with other network protocols as needed. For example, the viewer object proxy 504 can also be configured to operate in accordance with FTP, NNTP, RTP, RTSP, SMTP, or SHOUT etc.

The client computer 112 includes a host server routing database 520. This host server routing database 520 can include information related to external origin servers 118 accessible by the client computer 112. In an embodiment, host server routing database 520 is a subset of the entries in the routing database 234 found in the active directory 104.

The client computer 112 includes a network interface 516 that connects the viewer object proxy 504 to the Internet 120. Common examples of network interfaces 516 include analog modems, DSL modems, ISDN, cable modems, satellite modems, cellular modems, power line modems, line-of-sight microwave modems, line-of-sight laser modems, etc.

In this embodiment, the client computer is associated with a home user. In other embodiments, the client computer could serve digital movies to a theater or provide content objects to a corporate network user, a hotel patron or apartment complex.

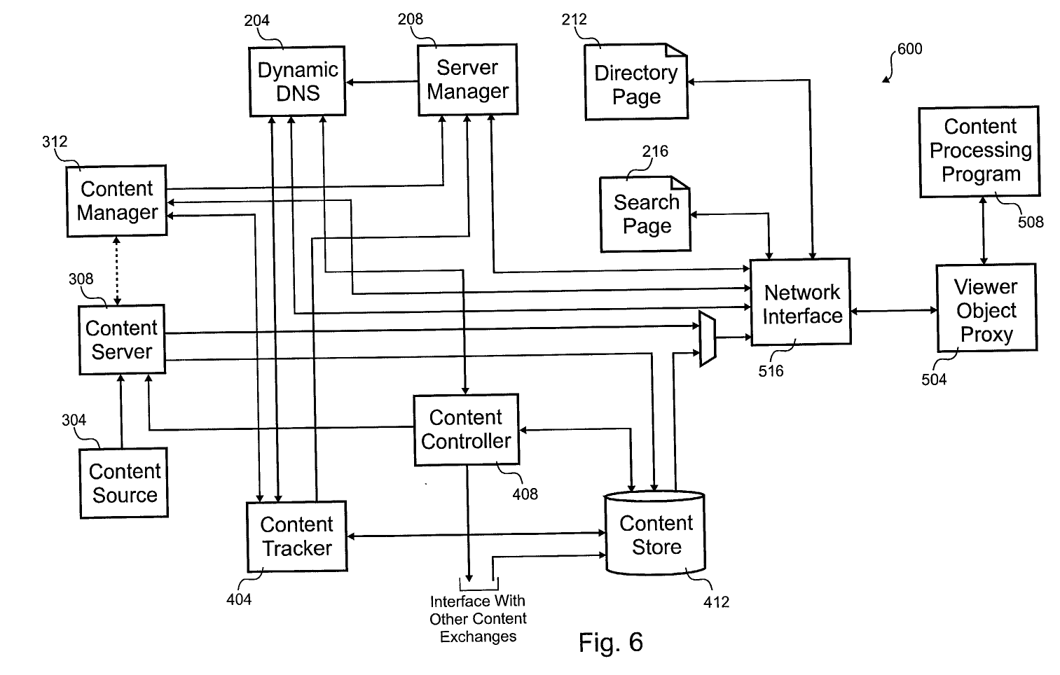

With reference to FIG. 6, a block diagram of an embodiment of a content distribution system 600 is shown. This figure depicts data flow between data blocks without showing transport over the Internet 120 or any other network. It is to be understood, however, that the Internet 120 or another packet switched network is used in some embodiments. Also, the figure is somewhat simplified in that some blocks from FIGS. 2-5 and the external origin server(s) 118 and crawling directory 124 are not included to simplify the FIG. 6.

The network interface 516 is the connection to the Internet 120 for the client computer 112. The client computer 112 connects to the directory and search pages 212, 216 to allow the user to select content objects for download. When a content object is selected, redirection of the client computer 112 from the active directory 104 to the appropriate origin server 108 uses the dynamic DNS 204. Preference information 512 is passed to the content manager 312 to assist its selection of the source for the content object. Depending on the selection made by the content manager 312, the content object is downloaded from one of the content exchanges 116 or from the content server 308.

The active directory 104 interacts with the other modules in the system 600. The client computer 112 accesses the directory and search pages 212, 216 to select a content object. The content tracker 404 and content manager 312 respectively provide status and catalog information to the server manager 208. Account information is provided to the server manager 208 by the administrator of the origin server 108 and by the user of client computer 112 to maintain the subscriber database 224. Redirection from the origin server name to the IP address of the origin server 108 is provided to the viewer object proxy 504, the content tracker 404 and the content controller 408 by the dynamic DNS 204.

The origin server 108 communicates with the server manager 208, the client computer 112, the content tracker 404, the content store 412, and the content controller 408. The local content catalog 316 is provided to the server manager 208 from the content manager 312 in order to maintain the server database 228 with current content information. Preference information 512 is provided to the content manager 312 from the client computer 112 to facilitate selection of a source of the content object. The content tracker 404 interacts with the content manager 312 to know what content objects are stored on the content exchange 116. Content objects are read from the content server 308 by either the content store 412 or the client computer 112.

The content exchanges 116 interact with the other modules in the system 600 as well. Status information is provided to the active directory 104 and/or the content manager 312. The dynamic DNS is used by both the content controller 408 and the content tracker 404 to find the IP address of an origin server 108 that contains a content object. A selected content exchange may contact other content exchanges when an object is needed for the content store 412. If the other content exchanges do not have the content object, the content controller 408 requests the object from the content server 308 for delivery to the selected content store 412.

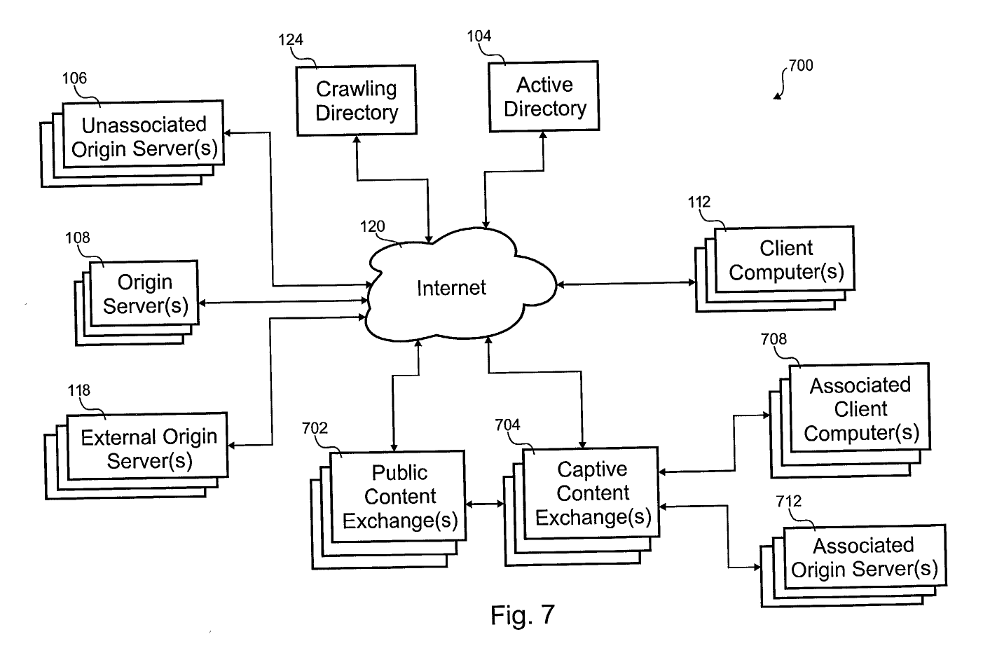

Referring next to FIG. 7, a block diagram of another embodiment of the content distribution system 700 is shown that has two types of content exchanges 702, 704. This embodiment includes public content exchanges 702 and captive content exchanges 704. One or more associated client computers 708 and one or more associated origin servers 712 are grouped with the one or more captive content exchanges 704. The public content exchanges 702 are available to source content objects to any of the client computers 112 or any of the associated client computers 708. Those content objects stored on the public content exchanges 702 could originate from any of the unassociated origin servers 106, origin servers 108, external origin servers 118, or associated origin servers 712.

The captive content exchanges 704, however, are not fully available to the system 700 in the same way as the public content exchanges 702 are. The captive content exchanges 704 cache content objects originating from associated origin servers 712. Those cached objects are provided to either the associated client computers 708 or client computers 112. Content objects originating from the unassociated origin servers 106, origin servers 108 and external origin servers 118 are cached for associated client computer 708, but not for client computers 112. The client computers 112 cannot rely on the captive content exchanges 704 for caching content objects that were sourced from any unassociated origin servers 106, origin servers 108 or external origin servers 118. Accordingly, the preference information 512 for the client computer 112 only includes public content exchanges 702 and not captive content exchanges 704.

The captive content exchanges 704 in this embodiment are linked to the public content exchanges 702 such that missing content objects or portions of content objects may be passed between content exchanges 702, 704 when requested by a user. When a content object is requested from the preferred content exchange 702, 704 a local search is first performed for the content object or any portion of the content object. If that search fails, the other content exchanges 702, 704 are searched before resorting to requesting the content object from the origin server 106, 108, 118, 712 that first provided the content object to the system 700. Other embodiments, however, could go without passing files between the captive content exchanges 704 and public content exchanges 702.

In various embodiments, the captive content exchanges 704 could be located in the central office, headend, ISP location, or nodes where the Internet bandwidth begins to travel the “last mile” or final leg to the associated client computer 708. By moving the cache as close as possible to the destination, the potential bottlenecks are reduced to improve QOS. For example, a cable multi-system operator (MSO) providing service to associated client computers 708 by way of DOCSIS modems could have captive content exchanges 704 in the headend or in neighborhood nodes. In this way, the associated client computers 708 and associated origin servers 712 connect to the captive content exchange 704 to provide enhanced QOS through caching.

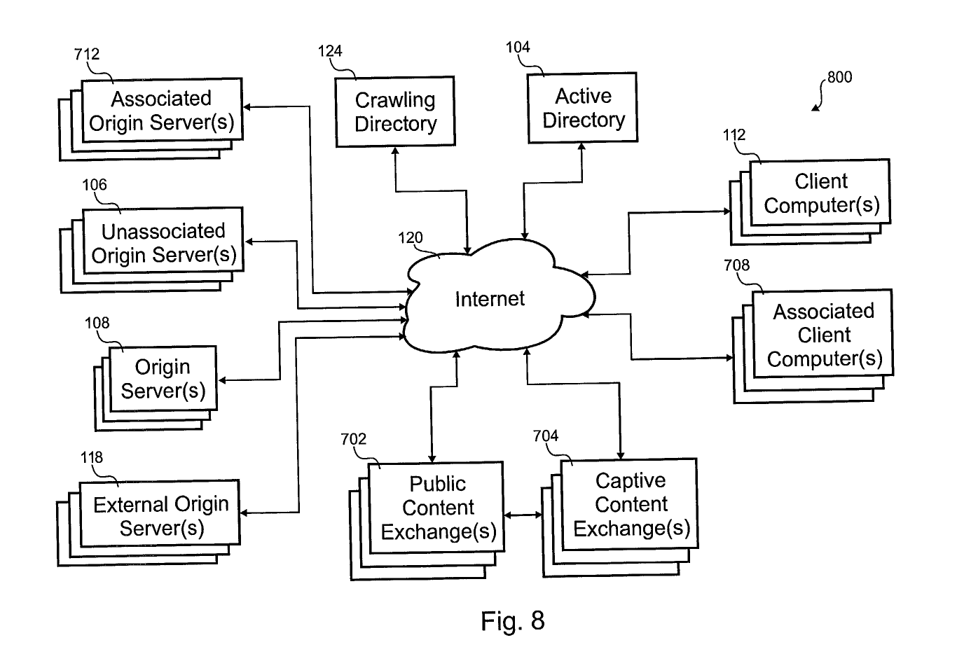

With reference to FIG. 8, a block diagram of yet another embodiment of the content distribution system 800 is shown. This embodiment demonstrates how the captive content exchange 704, associated client computers 708 and associated origin servers 712 can be virtually connected through the Internet 120. These functional blocks 704, 708, 712 could be coupled in any way. For example, the captive content exchanges 704 could be coupled to the associated client computers 708 through a hybrid fiber/cable distribution system. But, the associated origin servers 712 could be linked to the captive content exchanges 704 through the Internet 120.

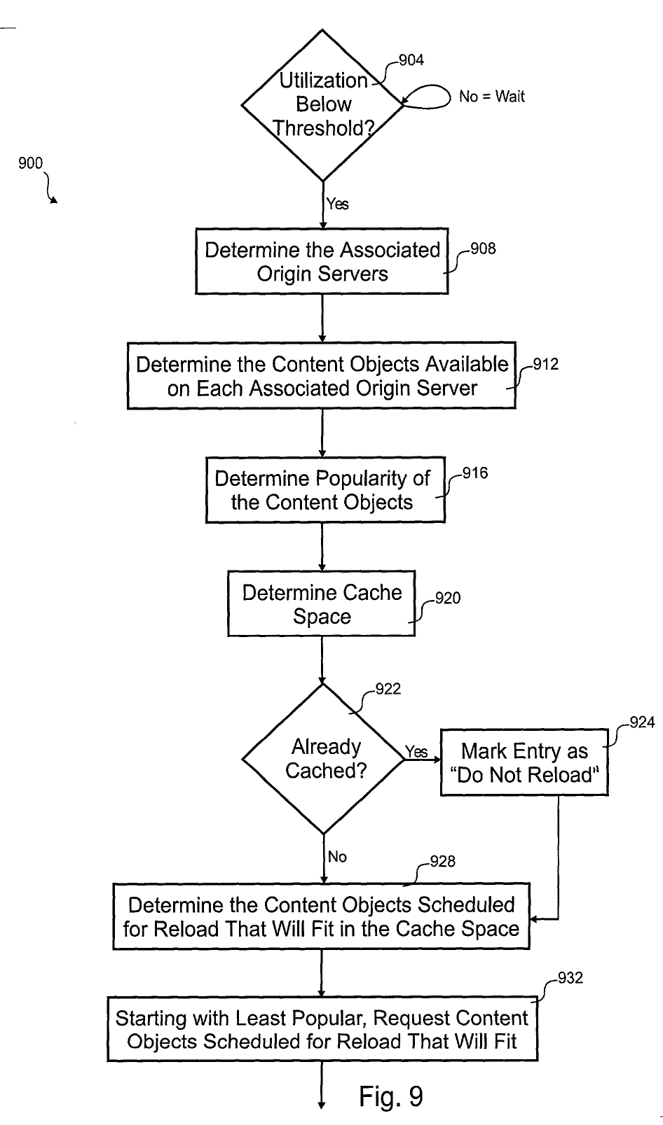

Referring next to FIG. 9, a flow diagram of an embodiment of a process 900 for populating captive content exchanges 704 that has available storage capacity is shown. The depicted process 900 picks-up in step 904 where a test detects bandwidth utilization below a threshold. The bandwidth measurement for this test could be the bandwidth from all associated origin servers 712 to the captive content exchange 704 in this embodiment or could be the bandwidth from a single associated origin server 712 to the captive content exchange 704 in other embodiments.

In step 908, a determination of which origin servers are associated origin servers 712 is made. The active directory 104 could be queried for this information or the information could be maintained local to the captive content exchange 704. Once the associated origin servers 712 are known, each local content catalog 316 is queried to determine the content objects available on that associated origin server 712 in step 912.

In step 916, the content objects from all the associated origin servers 712 are analyzed to determine a ranking between the content objects. In this embodiment, the popularity of the content objects controls the ranking. The number of times a content object is downloaded over the last day is the algorithm used for determining popularity, however, other embodiments could use other time periods. Although this embodiment uses popularity for ranking, other embodiments could also use size of the content object, price of the content object, and/or other factors when determining the ranking.

The associated origin servers 712 or captive content exchanges 704 could monitor popularity by respectively determining the number of click-throughs or hits for a content object. Click-throughs of the user of the client computer can be monitored with CGI scripts that redirect a content object selection back to the associated origin server 712. Once redirected back, the click-through is recorded and the client computer 112, 708 is redirected to the content exchange 702, 704 that serves as the source of the content object.

In step 920, a determination of how much cache space in the content store 412 will be allocated to storing the popular content objects. This embodiment uses half of the content store 412 to store popular content, but other embodiments could use other fractions of the capacity of the content store 412.

A determination is made in step 922 as to whether any of the content objects are stored in the content store 412 already. To determine what is already stored, the local content catalog 316 for the associated origin server 712 is cross referenced against the local content catalog 416 for the captive content exchange 704 to determine which of the content objects are not already stored in step 922. Those content objects that are already stored are marked as not needing any reload in step 924.

The highest ranked content objects that will fit into the allocated cache space and are not already loaded are determined in step 928. Those content objects that will not fit are removed from the list. Starting with the least popular on the ranked list, the content objects that are not already in the content store 412 are requested such that they are loaded onto the content store 412. The content objects that are already loaded on the content store 412 are moved to the front of the cache when their entry is reached when cycling through the list. In this way, all the popular content objects that will fit are loaded in the cache according to ranking. Those with lower rankings will be pushed out of the back of the cache first if there are no subsequent hits or requests for those content objects.

In some embodiments, each associated origin server 712 is harvested for content objects in a separate process that is run in parallel to other processes harvesting other associated origin servers 712. The bandwidth between a specific associated origin server 712 and the captive content exchange 704 is tested to determine if bandwidth utilization has fallen below a threshold. Once the threshold is crossed, the content objects are loaded onto the captive content exchange. In parallel, other associated origin servers 712 are harvested for content objects.

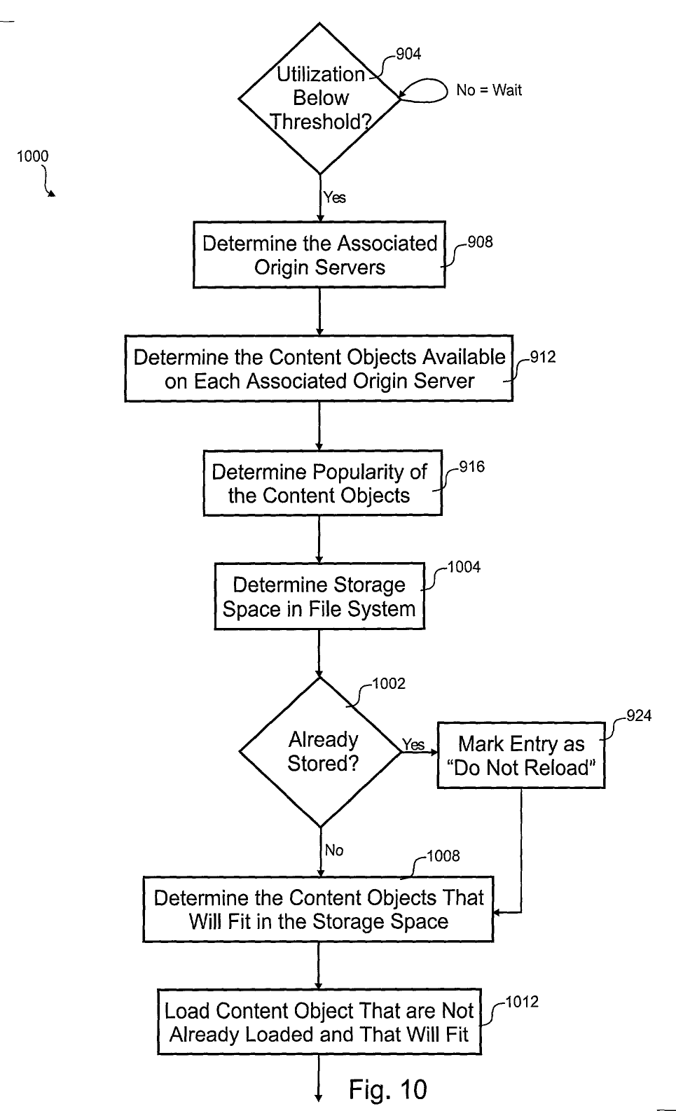

With reference to FIG. 10, a flow diagram of another embodiment of a process 1000 for populating the captive content exchange 704 is shown. In this embodiment, a file system rather than a cache is used. Content objects loaded into the file system remain until an expiration time. For example, a content object could be loaded one day with an expiration period of one day such that only twenty-four hours later can the file be overwritten.

The notable differences between this embodiment and the embodiment of FIG. 9 begin in step 1004 where the space in the file system reserved for preloading is determined. The file system space is logically separated from the space used for cacheing. Content objects that are stored on the file system should not be redundantly cached. In step 1002 and 924, entries for files that are already stored in the cache are marked such that they are not reloaded. The content objects that will not fit on the file system are removed from the list in step 1008. Any content objects that are not already loaded and that will fit are loaded in step 1012. The expiration time for all the content objects on the file system is set for one day or some other time period.

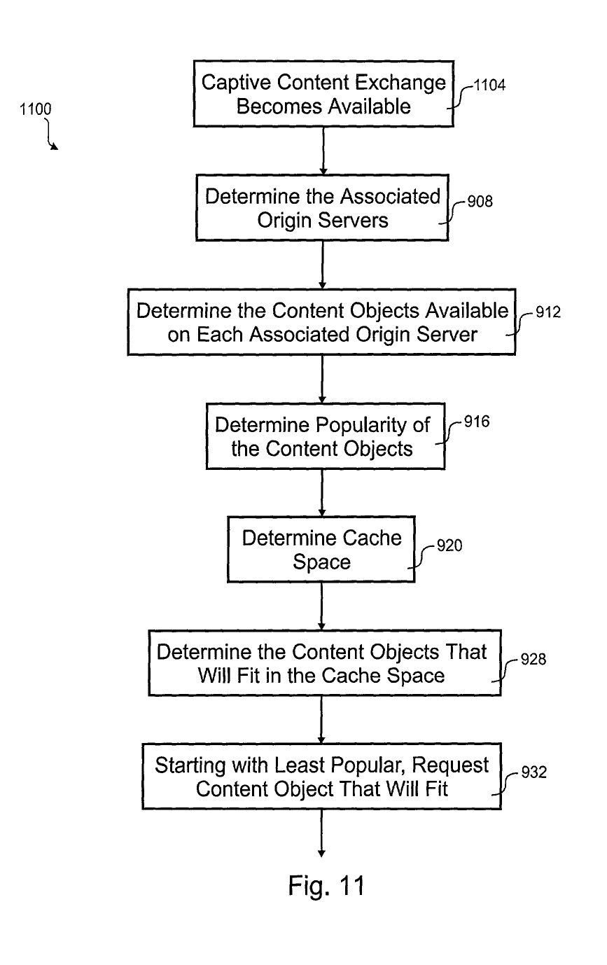

With reference to FIG. 11, a flow diagram of yet another embodiment of a process 1100 for populating the captive content exchange 704 is shown. In this embodiment, the captive content exchange 704 populates itself after becoming available to the system 700. For example, the captive content exchange 704 may populate itself after powering on. This embodiment does not determine which content objects are already stored in the cache. Instead, all content objects that are determined to fit are loaded.

The above embodiments in FIGS. 9-11 populate captive content exchanges 704. Other embodiments could also populate public content exchanges 702. A process in the active directory 104 would determine the popular content objects on the Internet and where those objects are likely to be requested from the distributed network of public content exchanges 702. The active directory could instruct public content exchanges 702 to preload content such that it is available with enhanced QOS.

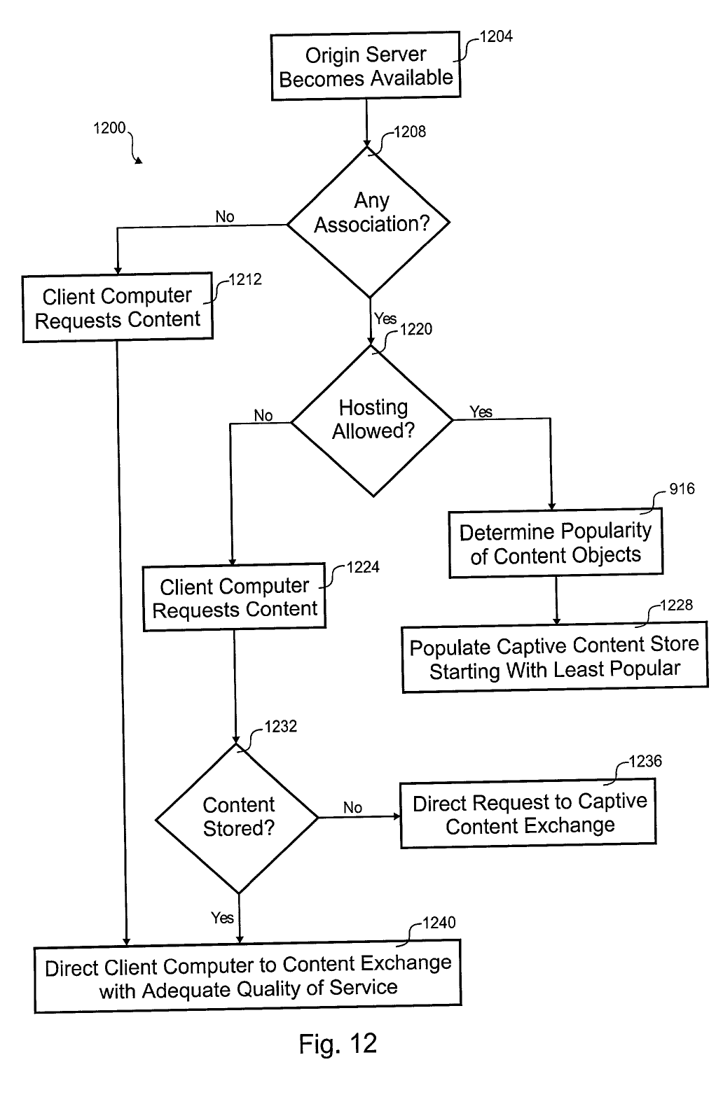

Referring next to FIG. 12, a flow diagram of an embodiment of a process 1100 for populating a distributed storage system with content from an origin server 106, 108, 118, 712 is shown. In this embodiment, the origin server 712 populates the captive content exchange 704 when it becomes available to the system 700 if hosting is allowed. The depicted process picks-up in step 1204 as the origin server 106, 108, 118, 712 comes online. In step 1208, a determination is made as to whether there is a captive content exchange 704 associated with the origin server 106, 108, 118, 712. Where there is no captive content exchange 704 no preloading occurs and processing continues to step 1212 and 1240 where the request for a content object is fulfilled by the preferred content exchange 702, 704.

In step 1220, a further determination is made as to whether hosting of the content objects on the captive content exchange 704 is allowed for this origin server 106, 108, 118, 712. A captive content exchange 704 may require compensation for the ability of an origin server 106, 108, 118, 712 to offload its content objects. If hosting is allowed, the popularity of the content objects is determined in step 916. In step 1228, the content objects are loaded onto the captive content exchange 704 such that the most popular objects are last to be expired out the back of the cache. Other embodiments could use a file system, with lifetime information specified for each content object as described above.

If hosting is not allowed in step 1220, conservation of upstream bandwidth is possible by first populating the captive content exchange 704 with the content object. Once the captive content exchange 704 has the content object it can propagate to other content exchanges 702, 704 efficiently. In step 1224, the client computer 112 requests the content from the origin server 106, 108, 118, 712. A determination in step 1232 is performed as to whether the content is already stored in any content exchange 702, 704. If the content is already stored in a content exchange 702, 704 away from the origin server 106, 108, 118, 712, the client computer 112 is directed to the preferred content exchange 702, 704 in step 1240. If needed, the preferred content exchange 702, 704 can get the content object from any other content exchange 702, 704 that already has the content object.

If the content object is not available on the distributed storage network of content exchanges 702, 704 as determined in step 1232, the client computer 112 is directed first to the captive content exchange 704 associated with the origin server 712. In this way, the captive content exchange 704 preferentially stores content objects from associated origin servers 712.

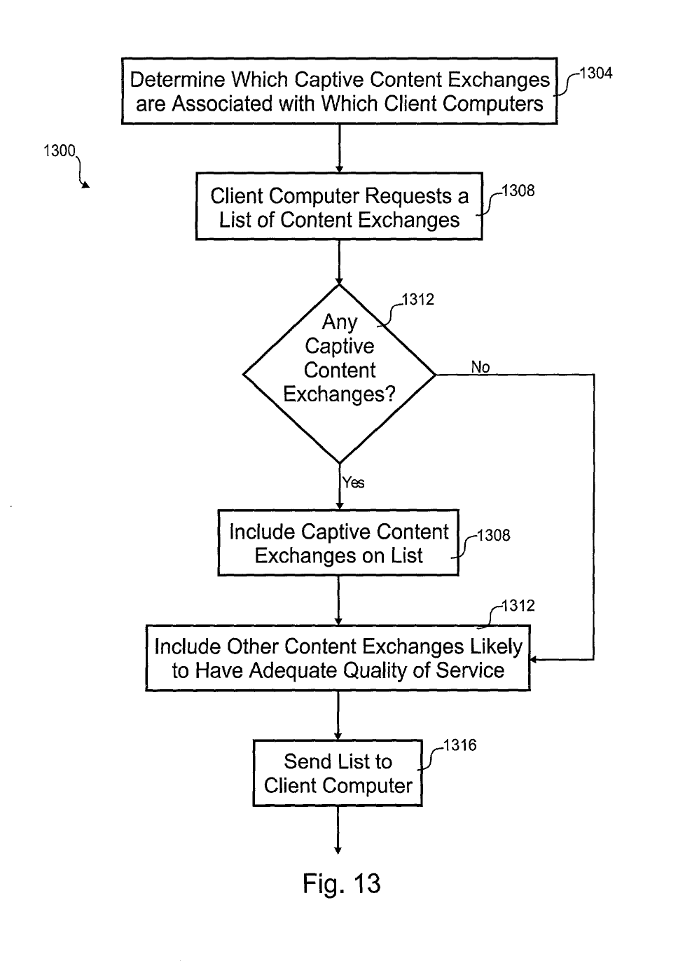

With reference to FIG. 13, a flow diagram of an embodiment of a process 1300 for providing a list of content exchanges 702, 704 to a client computer 112, 712 is shown. In this embodiment, a check for captive content exchanges 704 is performed before providing a list of preferred content exchanges 702, 704 to the client computer 708. The depiction of the process picks-up in step 1304 where a determination of which captive content exchanges 704 are associated with which associated client computers 708. These associations are recorded in a central location such as the active directory 104.

In step 1308, a client computer 112, 708 requests a list content exchanges 702, 704 from the active directory 104. A determination is made as to whether there are any captive content exchanges 704 in step 1312. If there are captive content exchanges 704, processing continues to step 1308 where those captive content exchanges 704 are included in the list. In step 1312, other public content exchanges 702 likely to have sufficient or adequate QOS are added to the list. If there are no captive content exchanges 704 as determined in step 1312, step 1308 is skipped and the list of preferred content exchanges 702 is assembled without any captive content exchanges 704.

Once the list of preferred content exchanges 702, 704 is assembled, it is sent to the client computer 112 in step 1316 and stored in the preference information database 512. The client computer 112 analyzes each content exchange 702, 704 on the list to rank them. Typically, the captive content exchanges 704 can provide the best QOS to associated client computers 708.

In light of the above description, a number of advantages of the present invention are readily apparent. For example, QOS is improved by preloading content objects onto a content exchange. By preloading based upon triggering events, the content object is passed through the upstream connection between the associated origin server and the captive content exchange in a controlled manner. Once a content object is offloaded to the captive content exchange, the associated origin server is likely to be less taxed by requests for the content object.

A number of variations and modifications of the invention can also be used. For example, some of the above embodiments detect low bandwidth utilization to trigger preloading of the content exchange. But, other embodiments could preload at a preset time, such as the middle of the night. Presumably, bandwidth utilization is at a minimum in the middle of the night.

While the principles of the invention have been described above in connection with specific apparatuses and methods, it is to be clearly understood that this description is made only by way of example and not as limitation on the scope of the invention.

What is claimed is:

1. A method for loading content objects in a content store on a network, the method comprising steps of:
waiting for a triggering event;
determining if a first origin server is authorized to store content in the content store;
loading a first content object from the first origin server onto the content store without a request for the first content object;
determining if a second origin server is authorized to store content in the content store; and
loading a second content object from the second origin server onto the content store without a request for the second content object.

2. The method for loading content objects in the content store on the network as recited in claim 1, further comprising a step of determining the popularity of the content object.

3. The method for loading content objects in the content store on the network as recited in claim 1, wherein the performance of the loading steps are conditioned on the waiting step.

4. The method for loading content objects in the content store on the network as recited in claim 1, wherein the waiting step comprises at least one of the following steps of waiting for:
upstream bandwidth between the first origin server and the content store to fall below a predetermined threshold; and
upstream bandwidth between the second origin server and the content store to fall below a predetermined threshold.

5. The method for loading content objects in the content store on the network as recited in claim 1, wherein the waiting step comprises a step of waiting for upstream bandwidth into the content store to fall below a predetermined threshold.

6. The method for loading content objects in the content store on the network as recited in claim 1, wherein the waiting step comprises a step of waiting for connection to the network.

7. The method for loading content objects in the content store on the network as recited in claim 1, wherein the waiting step comprises a step of waiting for upstream bandwidth utilization from a client computer to the content store to fall below a predetermined threshold.

8. The method for loading content objects in the content store on the network as recited in claim 1, wherein the waiting step comprises a step of waiting for a temporal event.

9. A method for loading content objects in a content store on a network, the method comprising steps of:
waiting for a triggering event;
determining the popularity of the content object;
loading a first content object from the first origin server onto the content store without a request for the first content object; and
loading a second content object from the second origin server onto the content store without a request for the second content object.

10. The method for loading content objects in the content store on the network as recited in claim 1, wherein the performance of the loading steps are conditioned on the waiting step.

11. The method for loading content objects in the content store on the network as recited in claim 1, further comprising steps of:
determining if a first origin server is authorized to store content in the content store; and
determining if a second origin server is authorized to store content in the content store.

12. The method for loading content objects in the content store on the network as recited in claim 1, wherein the waiting step comprises at least one of the following steps of waiting for:
upstream bandwidth between the first origin server and the content store to fall below a predetermined threshold; and
upstream bandwidth between the second origin server and the content store to fall below a predetermined threshold.

13. The method for loading content objects in the content store on the network as recited in claim 1, wherein the waiting step comprises a step of waiting for upstream bandwidth into the content store to fall below a predetermined threshold.

14. The method for loading content objects in the content store on the network as recited in claim 1, wherein the waiting step comprises a step of waiting for connection to the network.

15. The method for loading content objects in the content store on the network as recited in claim 1, wherein the waiting step comprises a step of waiting for upstream bandwidth utilization from a client computer to the content store to fall below a predetermined threshold.

16. The method for loading content objects in the content store on the network as recited in claim 1, wherein the waiting step comprises a step of waiting for a temporal event.

17. A method for loading content objects in a content store on a network, the method comprising steps of:
waiting for a triggering event;
loading a first plurality of content objects from the first origin server onto the content store without a request for any of the first plurality of content objects; and
loading a second plurality of content objects from the second origin server onto the content store without a request for the second plurality of content objects, wherein the performance of the loading steps are conditioned on the waiting step.

18. The method for loading content objects in the content store on the network as recited in claim 1, further comprising a step of determining the popularity of the content object.

19. The method for loading content objects in the content store on the network as recited in claim 1, further comprising steps of:
determining if a first origin server is authorized to store content in the content store; and
determining if a second origin server is authorized to store content in the content store.

20. The method for loading content objects in the content store on the network as recited in claim 1, wherein the waiting step comprises at least one of the following steps of waiting for:
upstream bandwidth between the first origin server and the content store to fall below a predetermined threshold; and
upstream bandwidth between the second origin server and the content store to fall below a predetermined threshold.

21. The method for loading content objects in the content store on the network as recited in claim 1, wherein the waiting step comprises a step of waiting for upstream bandwidth into the content store to fall below a predetermined threshold.

22. The method for loading content objects in the content store on the network as recited in claim 1, wherein the waiting step comprises a step of waiting for connection to the network.

23. The method for loading content objects in the content store on the network as recited in claim 1, wherein the waiting step comprises a step of waiting for upstream bandwidth utilization from a client computer to the content store to fall below a predetermined threshold.

24. The method for loading content objects in the content store on the network as recited in claim 1, wherein the waiting step comprises a step of waiting for a temporal event.
